(19) United States
(12) Patent Application Publication
(10) Pub. No.: US 2012/0141149 A1
(43) Pub. Date: Jun. 7, 2012

(54) IMAGE FORMING APPARATUS, IMAGE FORMING METHOD, AND STORAGE MEDIUM

(75) Inventor: Masanori Ichikawa, Kawasaki-shi (JP)

(73) Assignee: CANON KABUSHIKI KAISHA, Tokyo (JP)

(21) Appl. No.: 13/300,527

(22) Filed: Nov. 18, 2011

(30) Foreign Application Priority Data
Dec. 6, 2010 (JP) 2010-271695

(51) Int. Cl. G03G 15/08

(52) U.S. Cl. 399/27

(57) ABSTRACT

An image forming apparatus determines whether image data is formed by a monochrome image or a color image and acquires a rotation number of a photosensitive drum of each color, which forms a latent image of the image data. The image forming apparatus stores a cumulative value of the acquired rotation number of the photosensitive drum of each color. In a case where it is determined that the image data is formed by a monochrome image, the image forming apparatus corrects a cumulative value corresponding to a color component in the stored cumulative value of each color, and determines a toner remaining amount of each color based on the corrected cumulative value of the color component and the stored cumulative value of black.

### BACKGROUND OF THE INVENTION

1. Field of the Invention

The present invention relates to an image forming apparatus, an image forming method, and a storage medium.

2. Description of the Related Art

Conventionally, in an image forming apparatus using an electronic photographing process, such as a digital multifunction peripheral, image forming is performed by causing toner to adhere to an electrostatic latent image on photosensitive drum from a developing device to form a visible image, and transferring and fixing the formed visible image on a recording paper. The toner to be used is stored in a toner storage unit in the developing device and a remaining amount of toner is detected by various toner remaining amount detection methods.

One of the toner remaining amount detection methods uses a rotation number of a photosensitive drum. Although an amount of toner used in printing an image of one sheet is changed according to the number of characters, an average value of the used amount toner has been empirically known. Further, the rotation number of the photosensitive drum for printing one image is determined according to a diameter of the photosensitive drum and a printing size. Therefore, an approximate value of the remaining amount of toner can be calculated from a cumulative value of the rotation number of the photosensitive drum. For example, Japanese Patent application Laid-Open No. 2004-086232 discusses a technology to calculate the remaining amount of toner.

However, according to specifications of a printer engine responsible to control the photosensitive drum, an image forming apparatus may not perform to control the rotation/not-rotation of the photosensitive drum according to an image to be printed. In other words, there is a printer engine which always uniformly rotates four photosensitive drums for, i.e., cyan (C), magenta (M), yellow (Y), and black (K) when images are printed. For example, when the image forming apparatus prints a monochrome image, toners of C, M, and Y are not used but three photosensitive drums of C, M, and Y are also rotated like the photosensitive drum of K. In the image forming apparatus including such a printer engine, for detecting the remaining amount of toner, when an approximate value of the remaining amount of toner is calculated from a cumulative value of the rotation number of the photosensitive drum, the calculation causes a reduction in detection accuracy of the remaining amount of toner.

### SUMMARY OF THE INVENTION

The present invention is directed to an image forming apparatus capable of calculating a cumulative value of the rotation number of a photosensitive drum with high accuracy with respect to any kinds of image data and determining the remaining amount of toner with high accuracy when the remaining amount of toner is detected from the cumulative value of the rotation number of the photosensitive drum.

According to an aspect of the present invention, an image forming apparatus includes a determination unit, a storing unit, a correction unit, and a toner remaining amount determination unit. The determination unit is configured to determine whether image data is formed by a monochrome image or a color image. The storing unit is configured to acquire a rotation number of a photosensitive drum of each color, which forms a latent image of the image data, and to store a cumulative value of the acquired rotation number of the photosensitive drum of each color. The correction unit is configured to correct a cumulative value corresponding to a color component in the cumulative value stored by the storing unit, in a case where the determination unit determines that the image data is formed by a monochrome image. The toner remaining amount determination unit is configured to determine a toner remaining amount of each color based on the cumulative value of the color component corrected by the correction unit and a cumulative value of black stored by the storing unit.

According to an exemplary embodiment of the present invention, by correcting a cumulative value of the rotation number according to a content of image data, the image forming apparatus can acquire the cumulative value of the rotation number for any kinds of image data with high accuracy and thereby, can determine the remaining amount of toner with high accuracy.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an entirety of configuration of an image processing system according to a first exemplary embodiment of the present invention.

FIG. 2 illustrates a configuration of a printer image processing unit according to the first exemplary embodiment.

FIG. 3 illustrates a configuration of a printer engine according to the first exemplary embodiment.

FIG. 4 illustrates a configuration of a photosensitive drum rotation number storing unit according to the first exemplary embodiment.

FIG. 5 illustrates a configuration of a cartridge of each color according to the first exemplary embodiment.

FIG. 6 illustrates a configuration of an image component determination unit according to the first exemplary embodiment.

FIGS. 7A to 7C are flowcharts illustrating a toner remaining amount detection method according to the first exemplary embodiment.

FIG. 8 illustrates a transition of a cumulative value of the rotation number of a photosensitive drum according to the first exemplary embodiment.

FIG. 9 illustrates a configuration of a photosensitive drum rotation number storing unit according to a second exemplary embodiment of the present invention.

FIG. 10 illustrates a configuration of an image component determination unit according to the second exemplary embodiment.

FIG. 11 illustrates a transition of a cumulative value of the rotation number of a photosensitive drum according to the second exemplary embodiment.

FIGS. 12A to 12C are flowcharts illustrating a toner remaining amount detection method according to a third exemplary embodiment of the present invention.

FIG. 13 illustrates a transition of a cumulative value of the rotation number of a photosensitive drum according to the third exemplary embodiment.

### DESCRIPTION OF THE EMBODIMENTS

Various exemplary embodiments, features, and aspects of the invention will be described in detail below with reference to the drawings.

As an example of an image forming apparatus including a toner remaining amount detection method according to exemplary embodiments of the present invention, a digital multifunction peripheral having a plurality of functions, such as scanning, printing, and copying, will be described.

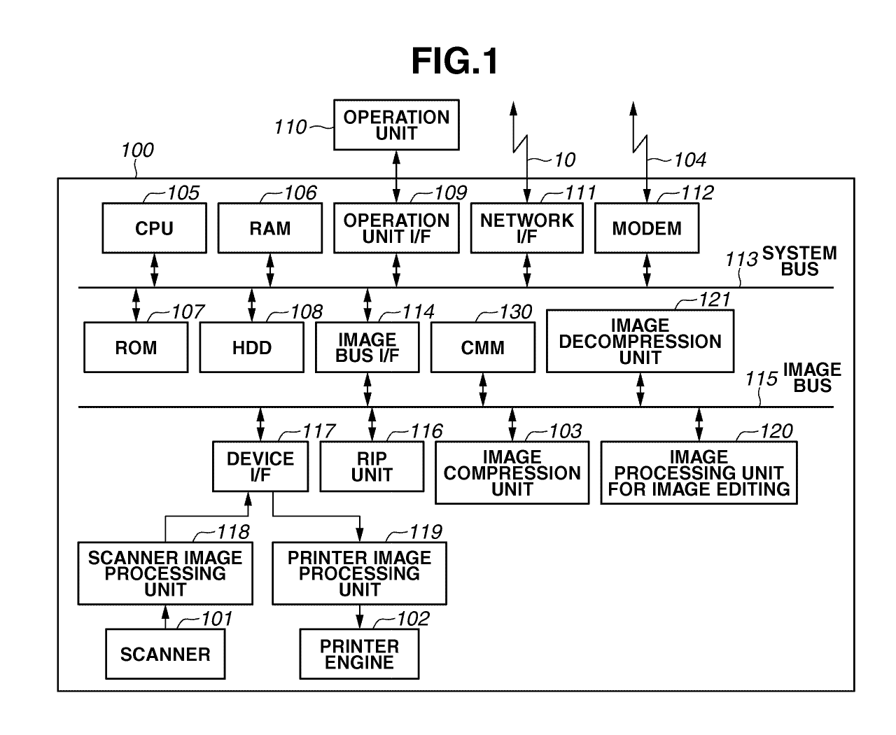

FIG. 1 is a block diagram illustrating an entirety of an image processing system according to a first exemplary embodiment of the present invention. In FIG. 1, a scanner 101, which is an image input device, and a printer engine 102, which is an image output device, are connected inside an image forming apparatus 100 via a printer image processing unit 119. The printer image processing unit 119 performs image processing on the printer side to received data. The image forming apparatus 100 controls reading and printing image data. Further, the image forming apparatus 100 controls input/output of image information and device information via a local area network (LAN) 10 by connecting to the LAN 10 and a public telephone line 104.

A central processing unit (CPU) 105 controls the image forming apparatus 100. A random access memory (RAM) 106 is a system work memory for operation of CPU 105. The RAM 106 also is an image memory for temporally storing input image data. Further, a read only memory (ROM) 107 is a boot ROM and stores a boot program of the system. A hard disk drive (HDD) 108 stores system software for various processing and input image data. An operation unit interface (I/F) 109 is an interface unit to an operation unit 110 including a display screen capable of displaying image data and outputs operation screen data to the operation unit 110. Further, the operation unit I/F 109 transfers information input by an operator from the operation unit 110 to the CPU 105. A network I/F 111 is realized by, for example, a LAN card and connects to the LAN 10 to perform input/output of information between the image forming apparatus 100 and an external apparatus. Furthermore, a modem 112 connects to the public telephone line 104 and performs input/output of information between the image forming apparatus 100 and an external apparatus. These units are located on a system bus 113.

An image bus I/F 114 is an interface for connecting the system bus 113 and an image bus 115, which transfers image data at high rate, and is a bus bridge which converts a data structure. On the image bus 115, a raster image processer (RIP) unit 116, a device I/F 117, a scanner image processing unit 118, an image processing unit for image editing 120, an image compression unit 103, an image decompression unit 121, and an image component determination unit 130 are connected. These are described in detail as follows.

The raster image processor (RIP) unit 116 rasterizes page description language (PDL) code to image data. The device I/F connects to the scanner 101 and the printer engine 102 via the scanner image processing unit 118 and the printer image processing unit 119 and performs synchronous/asynchronous conversion of image data.

Further, the scanner image processing unit 118 performs various processing, such as correction, processing, and editing, to image data input from the scanner 101. The image processing unit for image editing 120 performs various image processing of image data, such as rotation, magnification, coloring, trimming/masking, binary conversion, multivalued conversion, and blank determination. The image compression unit 103 performs coding of image data by a predetermined compression method when the image data is stored at once in the HDD 108. The image data is processed by the RIP unit 116, the scanner image processing unit 118, and the image processing unit for image editing 120. Further, there is a case in which image data compressed in the HDD 108 is processed by the image processing unit for image editing 120 according to necessity or image-processed by the printer image processing unit 119 and then, is output by the printer engine 102. In such a case, the image decompression unit 121 decodes and decompresses the data which has been compressed and coded once. The printer image processing unit 119 performs, on image data to be print-output, image processing correction corresponding to a printer engine. The printer image processing unit 119 will be described in detail below. A color management module (CMM) 130 is an exclusive hardware module for performing color conversion processing, which is also said as color space conversion processing, on image data based on a profile or calibration data. The profile is information like a function for converting color image data displayed by a color space depending on an apparatus to a color space not depending on an apparatus (for example, Lab color space). The calibration data is used to correct a color reproduction characteristic of the scanner 101 or the printer engine 102.

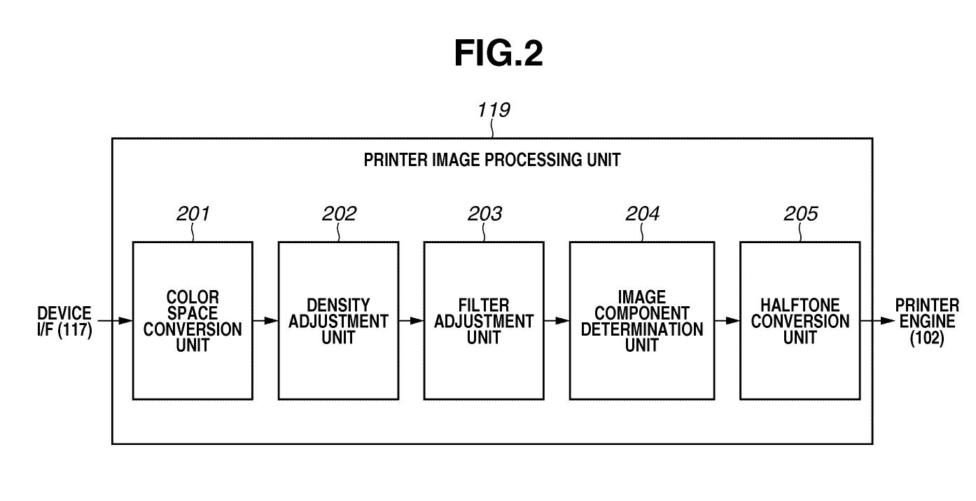

FIG. 2 is a block diagram illustrating an internal configuration of the printer image processing unit 119 provided in the image forming apparatus 100 according to the first exemplary embodiment. A color space conversion unit 201 converts color information of image data from a luminance value (red, green, and blue (RGB) data in the present exemplary embodiment) to a density value (CMYK data in the present exemplary embodiment). A density adjustment unit 202 adjusts a CMYK value of image data, for correcting a density output to a print product. A filter processing unit 203 performs filter processing, such as smoothing processing and screen processing. An image component determination unit 204 determines whether image data is configured with only a K component. A halftone conversion unit 205 converts a contone (continuous tone) value of each pixel to a halftone value.

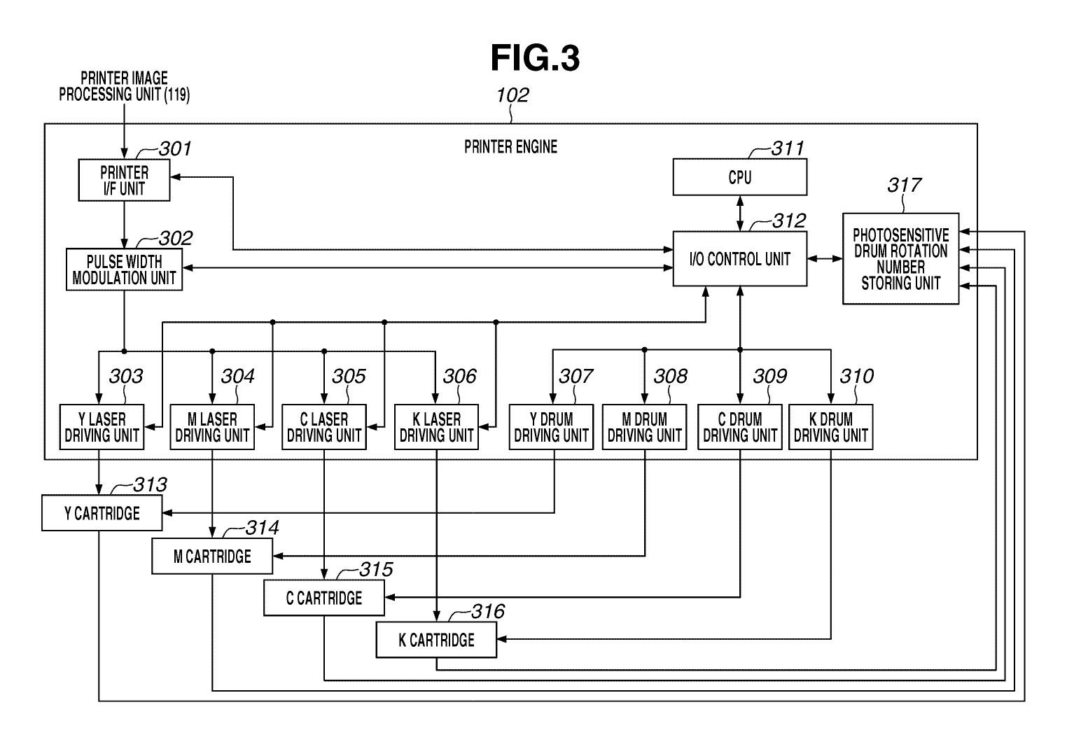

FIG. 3 is a block diagram illustrating a part of an internal configuration of the printer engine 102 provided in the image forming apparatus 100 according to the first exemplary embodiment. A printer I/F unit 301 receives color component data transmitted in order from the printer image processing unit 119 and outputs the color component data to a pulse width modulation circuit 302. The pulse width modulation circuit 302 generates a pulse signal for driving a laser drive unit of each color in later step (i.e., one of Y, M, C, and K laser drive units 303 to 306), and transmits the signal to each of laser drive units 303 to 306. The laser drive unit of each color (i.e., one of Y, M, C, and K laser drive units 303 to 306) drives a laser exposure device corresponding to each color based on the received pulse signal from the pulse width modulation circuit 302, and forms an electrostatic latent image on the photosensitive drum provided in cartridges of each color (i.e., one of Y, M, C, and K cartridges 313 to 316).

A drum drive unit (i.e., one of Y, M, C, and K drum drive units 307 to 310) respectively drives the photosensitive drum provided in cartridges of each color (i.e., one of Y, M, C, and K cartridges 313 to 316) in response of a drum rotation request from a CPU 311 via an input/output (I/O) control unit 312.

The CPU 311 controls the above-described control units and drive units via the I/O control unit 312. A photosensitive drum rotation number storing unit 317 counts up and stores a cumulative value of the rotation number of the photosensitive drum of each color according to a rotation detection signal of a cartridge of each color.

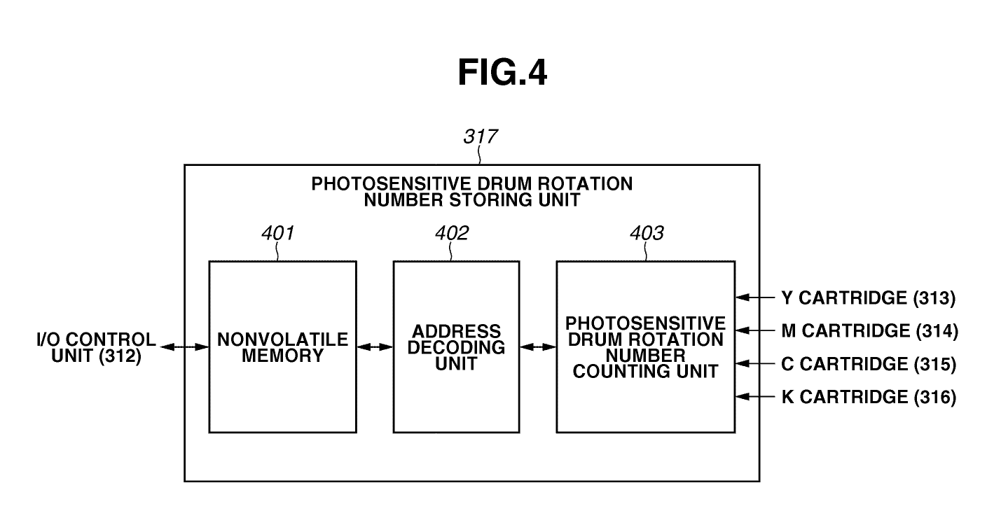

FIG. 4 is a block diagram illustrating an internal configuration of the photosensitive drum rotation number storing unit 317 according to the first exemplary embodiment. The photosensitive drum rotation number storing unit 317 includes a nonvolatile memory 401, an address decoding unit 402, and a photosensitive drum rotation number counting unit 403. The nonvolatile memory 401 is, for example, a ferroelectric random access memory (FeRAM) having two ports. The nonvolatile memory 401 stores the cumulative value of the rotation number of the photosensitive drum of each color counted by the photosensitive drum rotation number counting unit 403 described below. The cumulative value of the rotation number of the photosensitive drum of each color is read from the nonvolatile memory 401 by the address decoding unit 402 when the image forming apparatus 100 is started. Further, after printing is ended, a counter value indicating the cumulative value of the rotation number of the photosensitive drum of each color in the photosensitive drum rotation number counting unit 403 is written in the nonvolatile memory 401. The address decoding unit 402 writes the cumulative value of the rotation number of the photosensitive drum of each color, which is counted by the photosensitive drum rotation number counting unit 403, in a predetermined memory area in the nonvolatile memory 401. Further, when the image forming apparatus 100 is started, the address decoding unit 402 reads the cumulative value of the rotation number of the photosensitive drum of each color, which is stored in the predetermined memory area in the nonvolatile memory 401, and loads the cumulative value to the photosensitive drum rotation number counting unit 403. The photosensitive drum rotation number counting unit 403 detects a rotation detection signal indicating a rotation detection output from the cartridge of each color and counts up the cumulative value of the rotation number of the photosensitive drum of the corresponded color.

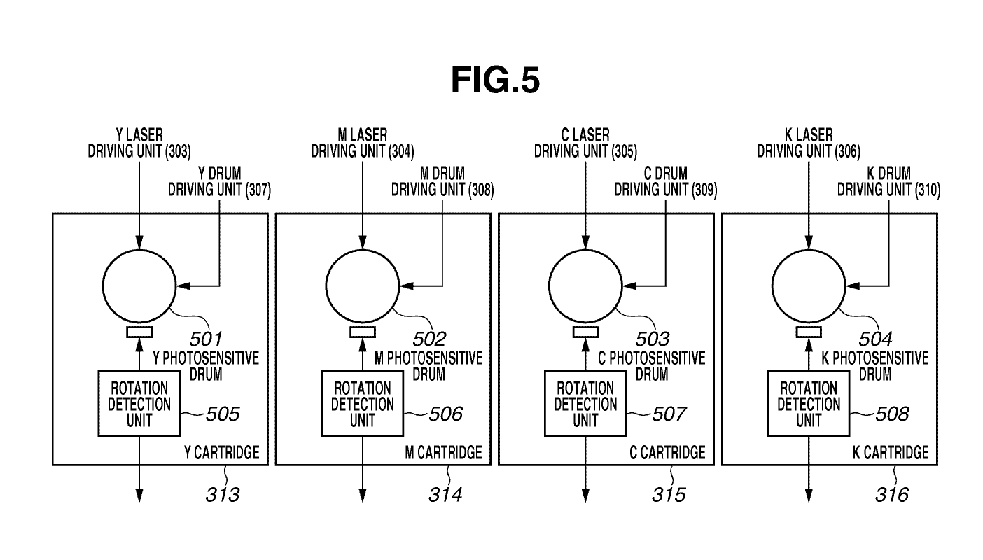

FIG. 5 is a block diagram illustrating a part of an internal configuration of the cartridges of each color 313 to 316 according to the first exemplary embodiment. Since the configuration of the cartridge of each color is the same, the Y cartridge 313 will be described as an example. The Y photosensitive drum 501 is driven by the Y drum drive unit 307. When an image is printed, the following steps are performed. The Y photosensitive drum 501 is charged by a charging control unit not illustrated. An electrostatic image is formed on the Y photosensitive drum 501 by the Y laser drive unit 303. The formed electrostatic image is developed by a Y developer not illustrated. The toner adhering to the Y photosensitive drum 501 is transferred to a recording sheet. The adhering toner is fixed on the recording sheet. The rotation detection unit 505 detects a rotation of the Y photosensitive drum 501. When the rotation is detected, the rotation detection unit 505 notifies the photosensitive drum rotation number storing unit 317 with a rotation detection signal.

With the aforementioned configuration, a series of operations by the image forming apparatus 100, i.e., from receiving a print job from the LAN 100 until printing, will be described.

At first, page description language (PDL) code transmitted via the LAN 10 is received by the network I/F 111 and is input from the image pass I/F to the RIP unit 116. The RIP unit 116 interprets the transmitted PDL code, converts it to code data which can be processed by the RIP unit 116, and executes rendering based on the converted code data. The page data subjected to rendering by the RIP unit 116 is compressed by the image compression unit 103 in the later step and stored in the HDD 108 in order.

Then, the compressed data stored in the HDD 108 is decompressed by the image decompression unit 121.

The image data decompressed by the image decompression unit 121 is input to the image processing unit for image editing 120 if necessary, performs processing for image editing, and is input to the printer image processing unit 119 via the device I/F 117.

The image data input to the printer image processing unit 119 is converted, by the color space conversion unit 201, from the luminance value (RGB data in the present exemplary embodiment) to the density value (CMYK data in the present exemplary embodiment). The density adjustment unit 202 adjusts CMYK values of the image data, which has become CMYK data, for correcting density output to a print product. Then, the image data is processed by filter processing, such as smoothing processing and screen processing, by the filter processing unit 203. The image component determination unit 204 determines whether the image data, which has completed until the filter processing, is configured with only the K component. The processing by the image component determination unit 204 will be described in detail as follows. The half tone conversion unit 205 converts the contone values of each pixel of the image data output from the image component determination unit 204 to the halftone values and outputs the halftone values to the printer engine 102.

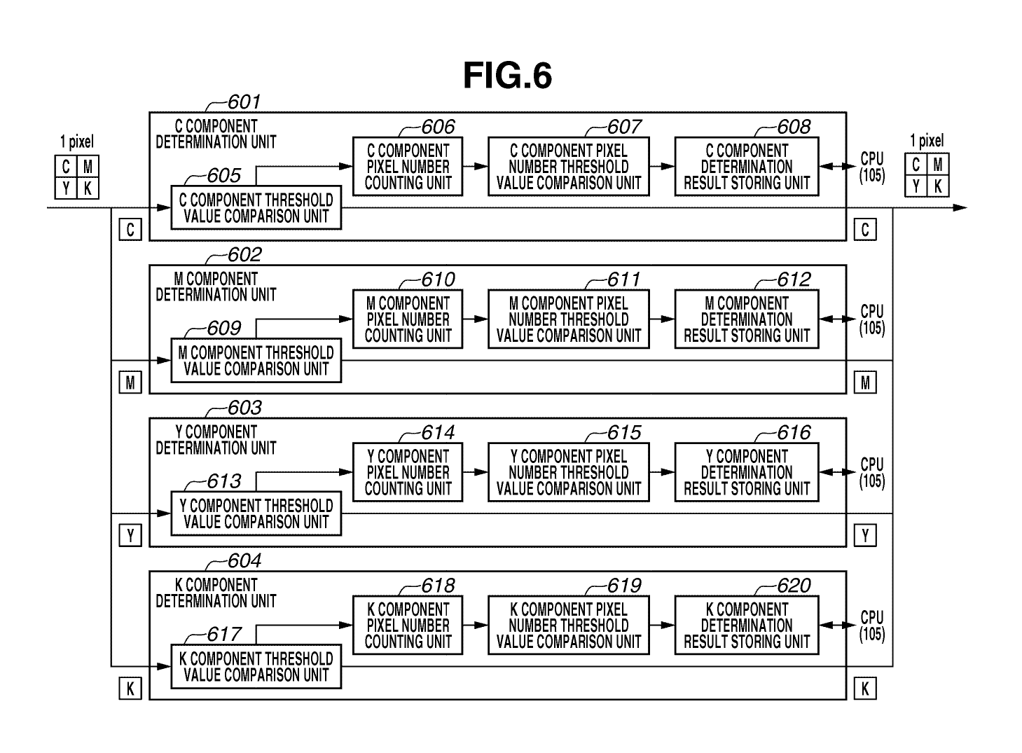

One example of the aforementioned determination performed by the image component determination unit 204 will be described in detail as follows, referring to FIG. 6. FIG. 6 is a block diagram illustrating an internal configuration of the image component determination unit 204. The image component determination unit 204 includes a C component determination unit 601, an M component determination unit 602, a Y component determination unit 603, and a K component determination unit 604. Since the internal configuration of the component determination unit of each color is the same, in the description of the present exemplary embodiment, the C component determination unit 601 will be described as an example.

The C component determination unit 601 includes a C component threshold value comparison unit 605, a C component pixel number counting unit 606, a C component pixel number threshold value comparison unit 607, and a C component determination result storing unit 608.

In the C component threshold value comparison unit 605, C data of each pixel is input in order, and the C component threshold value comparison unit 605 determines whether the input data is equal to or greater than a C component threshold value determined by the CPU 105 beforehand. When the C component threshold value comparison unit 605 determines that the input data is equal to or greater than the C component threshold value, the C component threshold value comparison unit 605 notifies the C component pixel number counting unit 606 to perform increment of a counter. The counter indicates the number of pixels in which the C component exists in the image to be printed. When the C component threshold value comparison unit 605 determines that the input data is smaller than the C component threshold value, the C component threshold value comparison unit 605 does not perform the increment notification to the C component pixel number counting unit 606.

The C component pixel number counting unit 606 performs the increment of the internal counter every notification of the increment of counter. However, the internal counter is cleared every page. Further, the count values stored in the C component pixel number counting unit 606 are always output to the C component pixel number threshold value comparison unit 607 in a later step.

The C component pixel number threshold value comparison unit 607 determines whether the input count value is equal to or greater than the C component pixel number threshold value which is set beforehand by the CPU 105. Only when the C component pixel number threshold value comparison unit 607 determines that the input count value is equal to or greater than the C component pixel number threshold value, the C component pixel number threshold value comparison unit 607 sets a flag indicating that there is the C component, which indicates that there is the C component in image data to be printed, in the C component determination result storing unit 608. However, the flag indicating that there is the C component is cleared every page. In addition, the C data, in which the determination processing by the C component threshold comparison unit 605 is ended, is output from the C component determination unit 601 and input to the halftone conversion unit 205 in order.

In addition, the image component determination unit 204 can perform a determination method other than the aforementioned method. For example, the image component determination unit 204 performs color/monochrome determination on image data and can determine whether the image data input by the image component determination unit 204 is color image data or monochromatic image data. In such a case, the color/monochrome determination can be performed by any one of public known color/monochrome determination method, for example, the color/monochrome determination method discussed in Japanese Patent Application Laid-Open No. 04-090675 can be used.

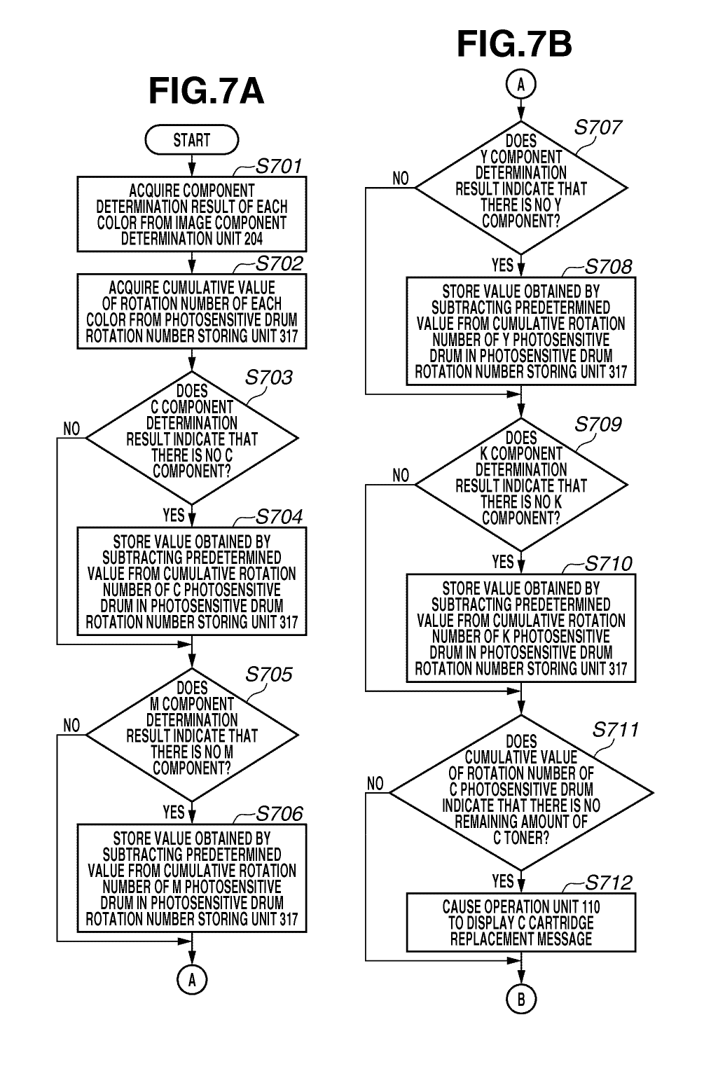

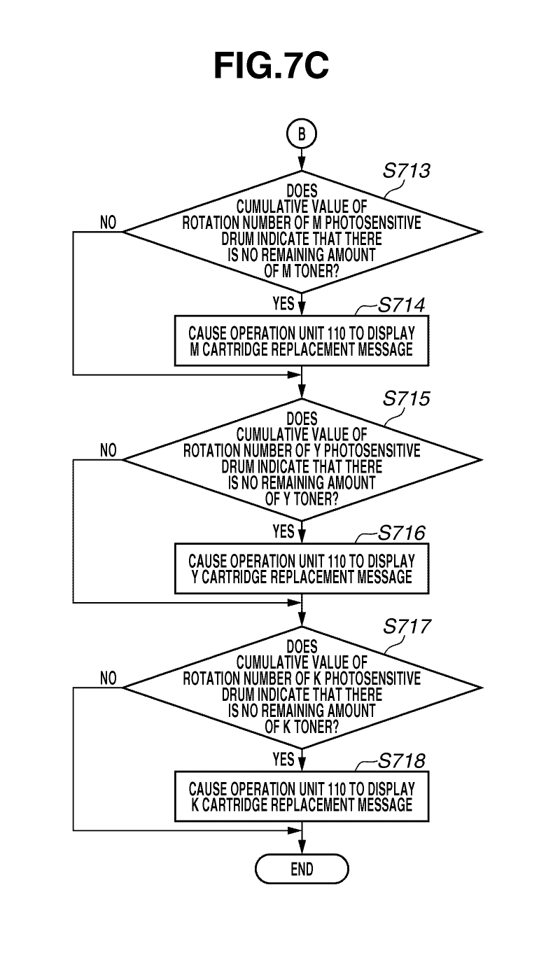

Further, in step S701 in FIG. 7A, the CPU 105 does not perform determination of image components and can acquire a color printing instruction or a monochrome printing instruction, which is input from the operation unit 110. In this case, when the color printing is instructed, the CPU 105 determines that there are the C component, the M component, the Y component, and the K component in the image data. Therefore, the processing in step S703, step S705, step S707, and step S709 in FIGS. 7A and 7B are determined as NO. On the other hand, when the monochrome printing is instructed, the CPU 105 determines that there are not the C component, the M component, and the Y component in the image data. Therefore, the processing in step S703, step S705, and step S707 are determined as YES. Further, the CPU 105 determines that there is the K component in the image data, so that the processing in step S709 is determined as NO. Further, when single color printing is instructed, for example, the printing using only the C component is instructed, the CPU 105 determines that there is only the C component, so that the processing in step S703 is determined as NO and the processing in step S705, step S707, and step S709 are determined as YES.

Further, the CPU 105 does not perform determination of image components and can determine whether the image data is color data or monochrome data, based on attribute information which is added to the image and indicates color data or monochrome data.

Then, an operation when image data output from the printer image processing unit 119 is input to the printer engine 102 will be described.

The image data output from the printer image processing unit 119 is received by the printer engine I/F unit 301 and transferred to the pulse width modulation circuit 302. The pulse width modulation circuit 302 generates, as described above, a pulse signal based on the input image data (color component data), and transmits the pulse signal to each of laser driving units 303 to 306. The each laser driving unit drives a laser exposure device (not illustrated) corresponding to each color based on the received pulse signal and forms an electrostatic latent image on the photosensitive drum of each color which is provided in cartridges 313 to 316 of each color. In addition, the drum driving units 307 to 310 of photosensitive drums of each color in conjunction with the input of image data to the printer engine 102.

The photosensitive drum driving units 307 to 310 of each color in the image forming apparatus 100 described in the present exemplary embodiment is controlled to cause all photosensitive drums of CMYK to drive at the time of image printing, not depending on a color component of the image to be printed. Further, the electrostatic latent image formed on the photosensitive drum is developed by the toner, transferred and fixed to a recording sheet, and then the printing of image data is completed. However, these processes are not features of the present exemplary embodiment, so that the description will be omitted.

With the aforementioned operations, the image forming apparatus 100 according to the first exemplary embodiment prints the PLD data received from the LAN 10.

Then, a toner remaining amount detection method will be described, referring to flowcharts in FIGS. 7A to 7C. The toner remaining amount detection method is performed after completion of the aforementioned serious image printing operations.

At first, in step S701, the CPU 105 acquires information of each of component determination results from the component determination result storing units 608, 612, 616, and 620 of each color in the image component determination unit 204. In step S702, the CPU 105 acquires a cumulative value of the rotation number of each photosensitive drum from the photosensitive drum rotation number storing unit 317. In step S703, the CPU 105 determines whether the aforementioned flag indicating that there is the C component is set, from the C component determination result acquired in step S701. When the CPU 105 determines that the flag indicating that there is the C component is not set, i.e., there is not the C component (YES in step S703), the processing proceeds to step S704.

In step S704, the CPU 105 subtracts a value set in the CPU 105 beforehand from the cumulative value of the rotation number of the C photosensitive drum, which is acquired in step S702, and writes the subtracted cumulative value in the photosensitive rotation number storing unit 317 to update the cumulative value. Meaning of this subtraction processing is to subtract the rotation number of the photosensitive drum, which is rotated at the time of printing of the image data in which the C toner is not used.

In addition, in step S701, the CPU 105 may acquire a result to determine whether the image data is color image data or monochrome image data, from the image component determination unit 204. When the acquired data is color image data, the processing in step S703, step S705, step S707, and step S709 are determined as NO. When the acquired data is the monochrome image data, the processing in step S703, step S705, and step S707 are determined as YES. The processing in step S707 is determined as NO.

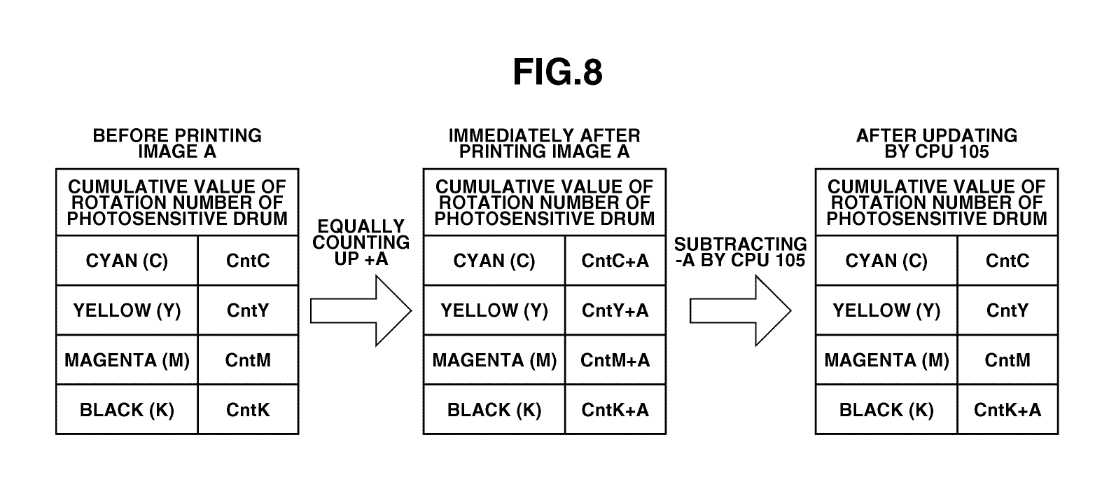

This process will be concretely described, referring to FIG. 8. FIG. 8 illustrates a transition of the cumulative value of the rotation number of the photosensitive drum of each color, which is stored in the photosensitive drum rotation number storing unit 317, for example, at the time of printing an image A which is a monochrome image. As illustrated in FIG. 8, the cumulative value of the rotation number of the photosensitive drum of each color before printing the image A is set to be that cyan (c) is “CntC”, yellow (Y) is “CntY”, magenta (M) is “CntM”, and black (K) is “CntK”. Here, CntC, CntY, CntM, and CntK are integers of 0 or more.

As described above, in the printer engine 102 provided with the image forming apparatus 100 of present exemplary embodiment, the photosensitive drums of C, M, Y, and K rotate at the predetermined rotation number not depending on the components of the image to be printed. Therefore, when the image A is printed, each photosensitive drum rotates at a predetermined rotation number A, so that the cumulative value of the rotation number of each photosensitive drum is counted up only the predetermined number A. The predetermined number A is determined by the photosensitive drum and the image size.

Then, the CPU 105 performs subtraction processing of the cumulative value of the rotation number of the photosensitive drum. In this case, since the image A is a monochrome image, in which only the a component in toners is used, C, M, and Y components in toners are not used. Therefore, for acquiring the accurate cumulative values of the rotation numbers of photosensitive drums of C, Y, and M, it is necessary to respectively subtract A from the cumulative values of rotation numbers of the photosensitive drums of C, Y, and M, which are counted up by printing the image A, that is, “CntC+A”, “CntY+A”, and “CntM+A”. After subtracting by the CPU 105, the cumulative values of the rotation numbers of the photosensitive drums of C, Y, and M become “CntC”, “CntY”, and “CntM”. In other words, the status of the cumulative values of the rotation numbers of the photosensitive drums of the toners, which are not used to print the image A, becomes the status of not increasing the cumulative values of the rotation numbers of the photosensitive drums. In addition, the determination processing of components M, Y, and K and the subtracting processing of the cumulative values of rotation numbers of the photosensitive drums according to the results of the determination processing will be performed in continuation of the flowcharts in FIGS. 7A to 7C as follows. However, these processing are the same as the processing of the component C, so that only the processing flow will be described and the description in detail will be omitted. Here, the C (cyan) component, M (magenta) component, and Y (yellow) component are described as a color component.

In step S703, when the CPU 105 determines that the flag indicating that there is the C component is set, i.e., there is the C component (NO in step S703), the CUP 105 does not update the cumulative value stored in the photosensitive drum rotation number storing unit 317 and the processing proceeds to step S705.

In step S705, the CPU 105 determines whether the aforementioned flag indicating that there is the M component is set, based on the M component determination result acquired in step S701. When the CPU 105 determines that the flag indicating that there is the component is not set, i.e., there is not the M component (YES in step S705), the processing proceeds to step S706.

In step S706, the CPU 105 subtracts the predetermined value set in the CPU 105 beforehand from the cumulative value of the rotation number of the M photosensitive drum, which is acquired in step S702, and writes the subtracted cumulative value in the photosensitive drum rotation number storing unit 317 to update the cumulative value.

In step S705, when the CPU 105 determines that the flag indicating that there is the M component is set, i.e., there is the M component (NO in step S705), the CUP 105 does not update the cumulative value stored in the photosensitive drum rotation number storing unit 317 and the processing proceeds to step S707.

In step S707, the CPU 105 determines whether the aforementioned flag indicating that there is the Y component is set, based on the Y component determination result acquired in step S701. When the CPU 105 determines that the flag indicating that there is the Y component is not set, i.e., there is not the Y component (YES in step S707), the processing proceeds to step S708.

In step S708, the CPU 105 subtracts the predetermined value set in the CPU 105 beforehand from the cumulative value of the rotation number of the Y photosensitive drum, which is acquired in step S702, and writes the subtracted cumulative value in the photosensitive drum rotation number storing unit 317 to update the cumulative value.

In step S707, when the CPU 105 determines that the flag indicating that there is the Y component is set, i.e., there is the Y component (NO in step S707), the CUP 105 does not update the cumulative value stored in the photosensitive drum rotation number storing unit 317 and the processing proceeds to step S709.

In step S709, the CPU 105 determines whether the aforementioned flag indicating that there is the K component is set, based on the K component determination result acquired in step S701. When the CPU 105 determines that the flag indicating that there is the K component is not set, i.e., there is not the K component (YES in step S709), the processing proceeds to step S710.

In step S710, the CPU 105 subtracts the predetermined value set in the CPU 105 beforehand from the cumulative value of the rotation number of the K photosensitive drum, which is acquired in step S702, and writes the subtracted cumulative value in the photosensitive drum rotation number storing unit 317 to update the cumulative value.

In step S709, when the CPU 105 determines that the flag indicating that there is the K component is set, i.e., there is the K component (NO in step S709), the CUP 105 does not update the cumulative value stored in the photosensitive drum rotation number storing unit 317 and the processing proceeds to step S711.

In step S711, the CPU 105 determines whether there is not the remaining amount of C toner, from the cumulative value of the rotation number of the C photosensitive drum. In this determination, for example, a predetermined threshold value is set beforehand, and the CPU determines whether the cumulative value of the rotation number of the C photosensitive drum becomes the threshold value or more. The determinations in the following step S713, step S715, and step S717 are the same determination in step S711.

When the CPU 105 determines that there is not the remaining amount of C toner in step S711 (YES in step S711), then in step S712, the CPU 105 causes the operation unit 110 to display a message indicating replacement of the C cartridge. When the CPU 105 determines that there is the remaining amount of C toner in step S711 (NO in step S711), the processing proceeds to step S713.

In step S713, the CPU 105 determines whether there is not the remaining amount of M toner, from the cumulative value of the rotation number of the M photosensitive drum.

When the CPU 105 determines that there is not the remaining amount of M toner in step S713 (YES in step S713), then in step S714, the CPU 105 causes the operation unit 110 to display a message indicating replacement of the M cartridge. When the CPU 105 determines that there is the remaining amount of M toner in step S713 (NO in step S713), the processing proceeds to step S715.

In step S715, the CPU 105 determines whether there is not the remaining amount of Y toner, from the cumulative value of the rotation number of the Y photosensitive drum.

When the CPU 105 determines that there is not the remaining amount of Y toner in step S715 (YES in step S715), then in step S716, the CPU 105 causes the operation unit 110 to display a message indicating replacement of the Y cartridge. When the CPU 105 determines that there is the remaining amount of Y toner in step S715 (NO in step S715), the processing proceeds to step S717.

In step S717, the CPU 105 determines whether there is not the remaining amount of K toner, from the cumulative value of the rotation number of the K photosensitive drum.

When the CPU 105 determines that there is not the remaining amount of K toner in step S717 (YES in step S717), then in step S718, the CPU 105 causes the operation unit 110 to display a message indicating replacement of the K cartridge. When the CPU 105 determines that there is the remaining amount of K toner in step S717 (NO in step S717), the processing ends.

With the aforementioned processing, the image forming apparatus 100 according to the first exemplary embodiment detects the remaining amount of toner from the cumulative value of the rotation number of the photosensitive drum of each color. In the first exemplary embodiment, the CPU 105 performs, every printing an image, the subtracting processing of the cumulative value of the rotation number of the photosensitive drum of each color according to the color component of the image to be printed. Therefore, in a printer engine like the printer engine 102 provided in the present exemplary embodiment, in which all photosensitive drums rotates not depending on an image to be printed, the image forming apparatus 100 can detect a remaining amount of toner, not receiving an effect of the rotation of the photosensitive drum when the toner is not used, so that upgrading of an accuracy of the remaining amount of toner can be acquired.

In the first exemplary embodiment, the CPU 105 performs subtraction processing on the cumulative value of the rotation number of the photosensitive drum of each color stored in the photosensitive drum rotation number storing unit 317, based on the determination result in the image component determination unit 204. However, in the first exemplary embodiment, the subtraction processing of the cumulative value of the rotation number of the photosensitive drum of each color by the CPU 105 is necessary every printing an image, so that load on the CPU 105 increases.

In a second exemplary embodiment of the present invention, the CUP 105 does not perform the subtraction processing, but the photosensitive drum rotation number storing unit 317 and the image component determination unit 204 automatically perform the processing equivalent to the subtraction processing. The specified configuration and processing of the second exemplary embodiment will be described as follows.

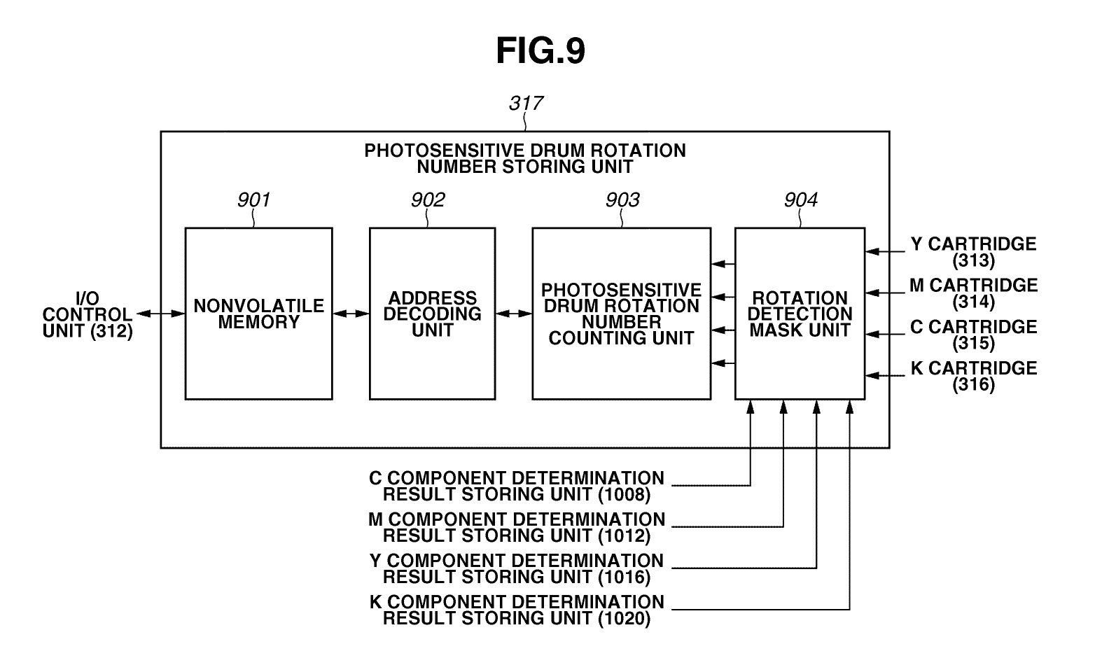

In the second exemplary embodiment, only configurations of the photosensitive drum rotation number storing unit 317 and the image component determination unit 204 are different from the first exemplary embodiment. FIG. 9 is a block diagram illustrating an internal configuration of the photosensitive drum rotation number storing unit 317. The photosensitive drum rotation number storing unit 317 includes a nonvolatile memory 901, an address decoding unit 902, a photosensitive drum rotation number counting unit 903, and a rotation detection mask unit 904. The nonvolatile memory 901, the address decoding unit 902, and the photosensitive drum rotation number counting unit 903 are similar to the first exemplary embodiment, so that the description will be omitted. The rotation detection mask unit 904 is a specific configuration element of the second exemplary embodiment. The rotation detection mask unit 904 receives a component determination result of each color from the component determination result storing units of each color, i.e., a C component determination result storing unit 1008, an M component determination result storing unit 1012, a Y component determination result storing unit 1016, and a K component determination result storing unit 1020, and performs mask processing of a rotation detection signal, according to results of each determination. The rotation detection signal indicates rotation detection input from cartridges of each color. The mask processing will be described in detail below.

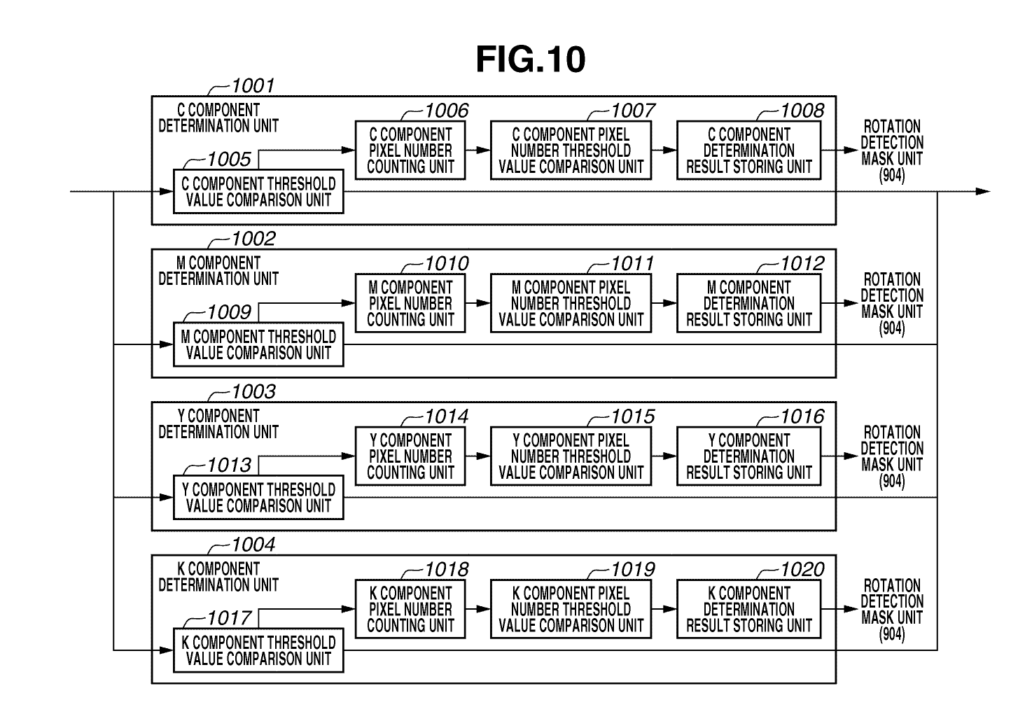

FIG. 10 is a block diagram illustrating an internal configuration of the image component determination unit 204. The image component determination unit 204 includes a C component determination unit 1001, an M component determination unit 1002, a Y component determination unit 1003, and a K component determination unit 1004. The internal configuration of the component determination unit of each color is the same, so that the C component determination unit 1001 will be described as an example.

The C component determination unit 1001 includes a C component threshold value comparison unit 1005, a C component pixel number counting unit 1006, a C component pixel number threshold value comparison unit 1007, and a C component determination result storing unit 1008. The C component threshold value comparison unit 1005, the C component pixel number counting unit 1006, and the C component pixel number threshold value comparison unit 1007 are similar to the first exemplary embodiment, so that these descriptions will be omitted.

The C component determination result storing unit 1008 stores a flag indicating that there is the C component, similar to the first exemplary embodiment. However, in the second exemplary embodiment, when the flag indicating that there is the C component is not set, the C component determination result storing unit 1008 always outputs a mask notification signal to the rotation detection mask unit 904. Further, when the flag indicating that there is the C component is set, the rotation detection mask unit 904 clears (cancels) the mask notification signal. However, the flag indicating that there is the C component is cleared before inputting a next page, and the mask notification signal to the rotation detection mask unit 904 is also cleared.

In addition, the image component determination unit 204 can perform a determination method other than the aforementioned method. For example, the image component determination unit 204 can perform color/monochrome determination and determine whether the image data input in the image component determination unit 204 is color image data or monochrome image data. About the color/monochrome determination method, a public known color/monochrome determination method can be used, for example, the color/monochrome determination method discussed in Japanese Patent Application Laid-Open No. 04-090675, can be used.

Further, the image component determination unit 204 can acquire an instruction of color printing or monochrome printing input from the operation unit 110, without performing determination of an image component.

Further, the image component determination unit 204 can perform color/monochrome determination based on attribute information indicating that image data is color data or monochrome data. The attribute information is added to the image.

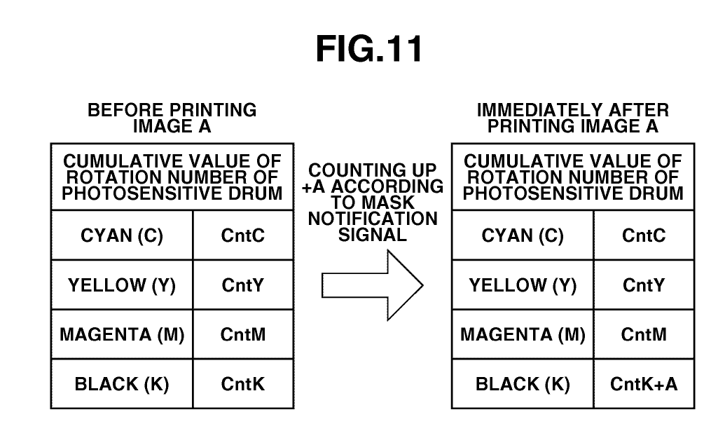

Then, a transition of the cumulative value of the rotation number of the photosensitive drum of each color stored in the photosensitive drum rotation number storing unit 317 in the second exemplary embodiment will be described, referring to FIG. 11. Like the first exemplary embodiment, the cumulative value of the rotation number of the photosensitive drum of each color when the image A is printed will be described. In the following descriptions, only the image component determination unit 204 and the photosensitive rotation number storing unit 317 are focused on.

In the image forming apparatus 100 according to the second exemplary embodiment, an image to be printed is input in the printer engine 102 after ending of the processing by the image component determination unit 204, and the photosensitive rotation number storing unit 317 counts up the cumulative value of the rotation number of the photosensitive drum of each color.

When the image A (monochrome image) is input, the image component determination unit 204 determines that there is not the C component in the image data, i.e., the flag indicating that there is C component is not set, similarly to the first exemplary embodiment. When the C component determination unit 1001 determines that there is not the C component, the C component determination result storing unit 1008 notifies a mask notification signal to the rotation detection mask unit 904. The rotation detection mask unit 904 masks a rotation detection signal from the C cartridge 313, since the C component determination result storing unit 1008 has notified the mask notification signal. By this mask processing, the rotation detection signal is not input to the photosensitive drum rotation number counting unit 903, so that the photosensitive drum rotation number counting unit 903 does not count up the cumulative value of the rotation number of the photosensitive drum. Therefore, as illustrated in FIG. 11, even immediately after printing the image A, the counting up of the cumulative value of the rotation number of the C photosensitive drum, which is performed in the first exemplary embodiment, is not performed. Further, similarly, counting up of the cumulative values of the rotation number of M and Y photosensitive drums is not performed. In addition, about the K component, the counting up of the cumulative value of the rotation number of the K photosensitive drum is performed.

Further processing, which detects the remaining amount of toner of each color by using the cumulative value of the rotation number of the photosensitive drums of each color, is similar to the first exemplary embodiment, so that the descriptions will be omitted.

In the second exemplary embodiment, as described above, since the CPU 105 performs control to count up the cumulative value of the rotation number of the photosensitive drum of each color, the accuracy of the toner remaining amount detection can be increased while reducing load on the CPU 105.

In the first and the second exemplary embodiments, the accuracy of the toner remaining amount detection is increased by correcting the cumulative value of the rotation number of the photosensitive drum of each color in the photosensitive drum rotation number storing unit 317 provided in the printer engine 102.

In a third exemplary embodiment of the present invention, the CPU 105 does not perform the subtraction processing of the cumulative value of the rotation number of the photosensitive drum of each color in the photosensitive drum rotation number storing unit 317. Instead of this, in the third exemplary embodiment, the CPU 105 updates, for each printing, only a correction value of the cumulative value of the rotation number of the photosensitive drum of each color, according to a determination result by the image component determination unit 204. In the third exemplary embodiment, the CPU 105 detects the toner remaining amount from this correction value and the cumulative value of the rotation number of the photosensitive drum of each color.

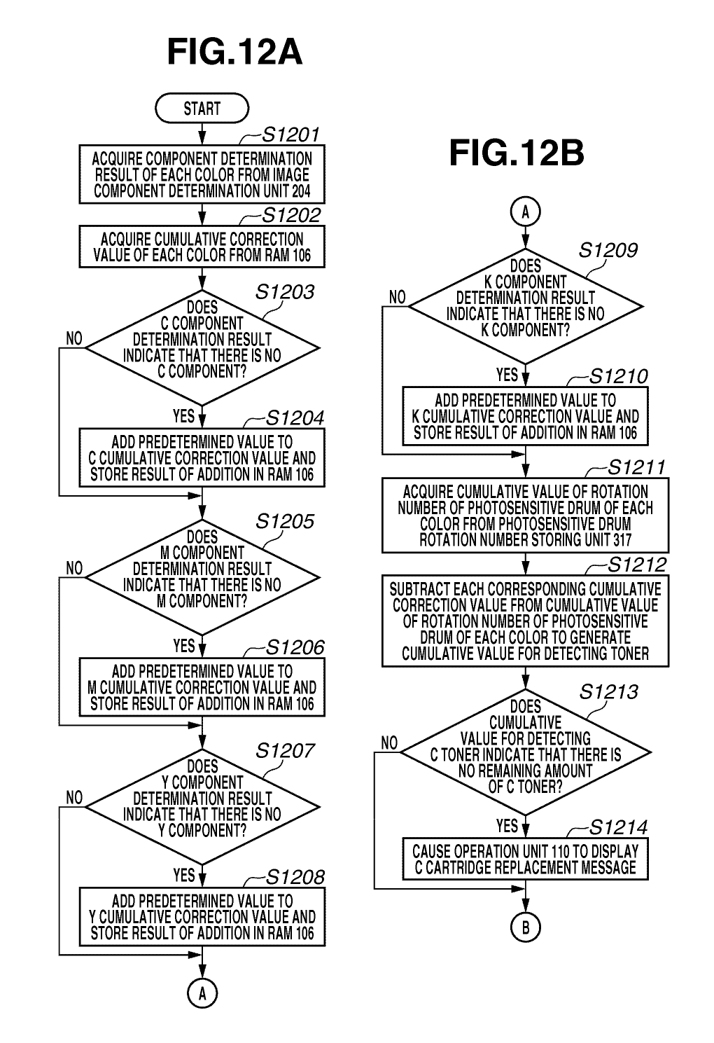

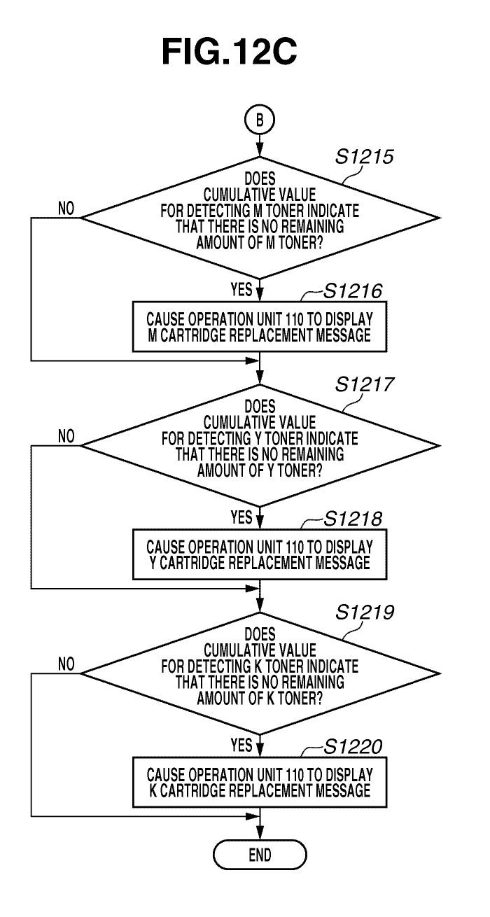

The configuration of the image forming apparatus 100 in the third exemplary embodiment is similar to the configuration of the first exemplary embodiment, so that the description will be omitted. The processing flow of the toner remaining amount detection in the third exemplary embodiment will be described. FIGS. 12A to 12C are flowcharts illustrating the processing flow of the toner remaining amount detection in the third exemplary embodiment.

In step S1201, the CPU 105 acquires a component determination result of each color from the image component determination unit 204.

In step S1202, the CPU 105 acquires, from the RAM 106, a cumulative correction value, which is a value for correcting the cumulative value of the rotation number of the photosensitive drum of each color and used at the time of detecting the toner remaining amount. The cumulative correction value is the correction value for generating a cumulative value of the rotation number of the photosensitive drum of each color at the time of detecting the toner remaining amount. Hereinafter, this cumulative value is referred to as a cumulative value for detecting the toner, in the third exemplary embodiment.

In the third exemplary embodiment, the cumulative value of the rotation number of the photosensitive drum of each color, which is stored in the photosensitive drum rotation number storing unit 317, indicates the cumulative value of the rotation number of the photosensitive drum actually rotated, not depending on use/not-use of the toner. The cumulative value for detecting the toner is obtained by subtracting the cumulative correction value from the cumulative value of the rotation number of the photosensitive drum actually rotated. The cumulative correction value indicates the cumulative value of the rotation number of the photosensitive drum when the toner is not used.

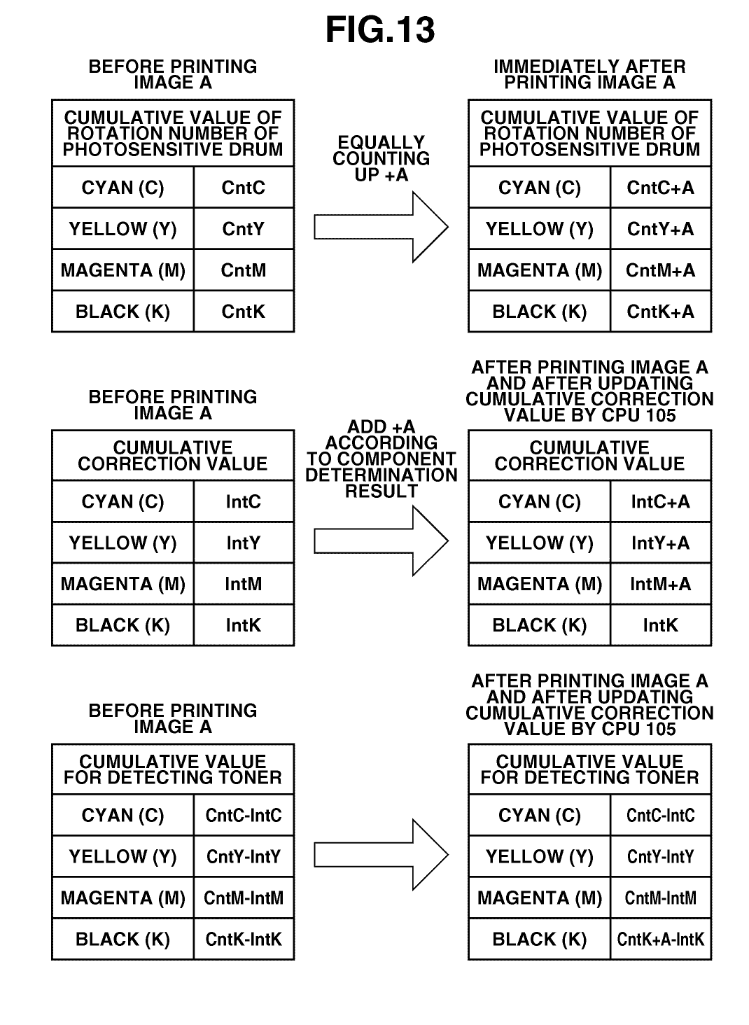

As illustrated in FIG. 13, in the third exemplary embodiment, the cumulative correction values of each color become that cyan is “IntC”, yellow is “IntY”, magenta is “IntM”, and black is “IntK”, where IntC, IntY, IntM, and IntK are integers of 0 or more.

Further, the CPU 105 reflects the cumulative correction value of each color stored in the RAM 106 to a predetermined area in the HDD 108 for backup. At the time of starting the image forming apparatus 100, the CPU 105 loads the cumulative correction value of each color stored in the predetermined area in the HDD 108 into the RAM 106.

In step S1203, the CPU 105 determines whether the flag indicating that there is the C component is set in the C component determination result acquired in step S1201. When the CPU 105 determines that the flag indicating that there is the C component is not set, i.e., there is not the C component (YES in step S1203), then in step S1204, the CPU 105 adds a predetermined value to the C cumulative correction value acquired in step S1202 to update the C cumulative correction value in the RAM 106. The addition to the C correction value means, as illustrated in FIG. 13, that the same value as the rotation number “A” of the photosensitive drum rotated by the printing is added to the cumulative correction value. When the CPU 105 determines that the flag indicating that there is the C component is set, i.e., there is the C component instep S1203 (NO in step S1203), the processing proceeds to step S1205.

In step S1205, the CPU 105 determines whether the flag indicating that there is the M component in the M component determination result acquired in step S1201. When the CPU 105 determines that the flag indicating that there is the M component is not set, i.e., there is not the M component (YES in step S1205), then in step S1206, the CPU 105 adds a predetermined value to the M cumulative correction value acquired in step S1202 to update the M cumulative correction value in the RAM 106. When the CPU 105 determines that the flag indicating that there is the M component is set, i.e., there is the M component (NO in step S1205), the processing proceeds to step S1207.

Instep S1207, the CPU 105 determines whether the flag indicating that there is the Y component in the Y component determination result acquired in step S1201. When the CPU 105 determines that the flag indicating that there is the Y component is not set, i.e., there is not the Y component (YES in step S1207), then in step S1208, the CPU 105 adds a predetermined value to the Y cumulative correction value acquired in step S1202 to update the Y cumulative correction value in the RAM 106. When the CPU 105 determines that the flag indicating that there is the Y component, i.e., there is the Y component, in step S1207 (NO in step S1207), the processing proceeds to step S1209.

Instep S1209, the CPU 105 determines whether the flag indicating that there is the K component in the K component determination result acquired in step S1201. When the CPU 105 determines that the flag indicating that there is the K component is not set, i.e., there is not the K component (YES in step S1209), then in step S1210, the CPU 105 adds a predetermined value to the K cumulative correction value acquired in step S1202 to update the K cumulative correction value in the RAM 106. When the CPU 105 determines that the flag indicating that there is the K component, i.e., there is the K component (NO in step S1209), the processing proceeds to step S1211.

In step S1211, the CPU 105 acquires the cumulative value of the rotation number of the photosensitive drum of each color from the photosensitive drum rotation number storing unit 317. In step S1212, the CPU 105 generates a cumulative value for detecting the toner of each color from the cumulative value of the rotation number of the photosensitive drum of each color acquired in step S1211 and the cumulative correction value of each color acquired and generated in steps S1202 to S1210. This cumulative value for detecting the toner will be described referring to FIG. 13.

The cumulative value for detecting the toner is, as described above, used for detecting the remaining amount of toner of each color, and obtained by subtracting the cumulative value of the rotation number of the photosensitive drum when the toner is not used from the cumulative value of the rotation number of the photosensitive drum. A case of cyan (C) will be described as an example. In FIG. 13, before printing the image A, the cumulative value of the rotation number of the C photosensitive drum is “CntC” and the C cumulative correction value is “IntC”. Thus, the cumulative value for detecting the C toner becomes “CntC−IntC”. After printing the image A, the cumulative value of the rotation number of the C photosensitive drum becomes “CntC+A” and the C cumulative correction value becomes “IntC+A” in step S1203 and step S1204. Thus, the cumulative value for detecting the C toner becomes “CntC+A”−“IntC+A”=“CntC−IntC”. The reason that the cumulative value for detecting the C toner is not changed between before and after printing the image A causes that the image A is a monochrome image and the C toner is not used. In addition, the similar processing as the C toner is performed for toners of M, Y, and K.

In step S1213, the CPU 105 determines whether the cumulative value for detecting C toner generated in step S1212 indicates that there is not a remaining amount of C toner. This determination processing is performed by comparing the cumulative value of the rotation number of the C photosensitive drum to the threshold value, as described in the first exemplary embodiment. When the CPU 105 determines that there is not the remaining amount of C toner in step S1213 (YES in step S1213), then in step S1214, the CPU 105 causes the operation unit 100 to display a message of replacement of the C cartridge. When the CPU 105 determines that there is the remaining amount of C toner in step S1213 (NO in step S1213), the processing proceeds to step S1215. In addition, the subsequent processing is similar to the processing in step S1213 and step S1214, so that the descriptions are omitted.

According to the above processing, the image forming apparatus 100 according to the third exemplary embodiment detects the remaining amount of toner of each color. In the third exemplary embodiment, the CPU 105 does not perform the direct correction to the cumulative value of the rotation number of the photosensitive drum of each color stored in the photosensitive drum rotation number storing unit 317. Instead of this, the image forming apparatus 100 has the cumulative correction value for correcting each color and updates the cumulative correction value for every image to be printed. When the remaining amount of toner is detected, the remaining amount can be obtained by subtracting the cumulative correction value of each color from the cumulative value of the rotation number of the photosensitive drum of each color, so that the accuracy of the remaining amount of toner detection can be increased, similarly to the first and the second exemplary embodiments. Further, in the third exemplary embodiment, the cumulative value of the rotation number of the photosensitive drum of each color stored in the photosensitive drum rotation number storing unit 317 is not directly corrected, so that the cumulative value of the actual rotation number of the photosensitive drum of each color can be stored.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-271695 filed Dec. 6, 2010, which is hereby incorporated by reference herein in its entirety.

What is claimed is:

1. An image forming apparatus comprising:
a determination unit configured to determine whether image data is formed by a monochrome image or a color image;
a storing unit configured to acquire a rotation number of a photosensitive drum of each color for forming a latent image of the image data and to store a cumulative value of the acquired rotation number of a photosensitive drum of each color;
a correction unit configured to correct a cumulative value corresponding to a color component in the cumulative value of each color stored by the storing unit, in a case where the determination unit determines that the image data is formed by a monochrome image; and
a toner remaining amount determination unit configured to determine a toner remaining amount of each color based on the cumulative value of the color component corrected by the correction unit and a cumulative value of black stored by the storing unit.

2. The image forming apparatus according to claim 1, wherein, in a case where the determination unit determines that the image data is formed by a color image, the correction unit does not correct the cumulative value corresponding to the color component, and the toner remaining amount determination unit determines the toner remaining amount of each color based on the cumulative value of each color stored by the storing unit.

3. The image forming apparatus according to claim 1, wherein the correction unit corrects the cumulative value corresponding to the color component by subtracting a rotation number of a photosensitive drum used to print the monochrome image from the cumulative value corresponding to the color component stored by the storing unit.

4. An image forming apparatus comprising:
a determination unit configured to determine whether image data is formed by an image including a predetermined color component;
a storing unit configured to acquire a rotation number of a photosensitive drum of each color for forming a latent image of the image data and to store a cumulative value of the acquired rotation number of the photosensitive drum of each color;
a correction unit configured to correct a cumulative value corresponding to the predetermined color component in the cumulative value of each color stored by the storing unit, in a case where the determination unit determines that the image data is not formed by an image including the predetermined color component; and
a toner remaining amount determination unit configured to determine a toner remaining amount of the predetermined color component based on the cumulative value corresponding to the predetermined color component corrected by the correction unit.

5. The image forming apparatus according to claim 4, wherein the correction unit corrects the cumulative value corresponding to the predetermined color component by subtracting a rotation number of a photosensitive drum used to print the image data from the cumulative value corresponding to the predetermined color component stored by the storing unit.

6. The image forming apparatus according to claim 4, wherein the predetermined color component includes at least one of cyan, magenta, yellow, and black.

7. An image forming apparatus comprising:
a determination unit configure to determine whether image data is formed by a monochrome image or a color image; and
a counting unit configure to count up a cumulative value of a rotation number of a photosensitive drum corresponding to black without counting up a cumulative value of a rotation number of a photosensitive drum corresponding to a color component, in a case where the determination unit determines that the image data is formed by a monochrome image.

8. The image forming apparatus according to claim 7, further comprising a toner remaining amount determination unit configured to determine a toner remaining amount of each color based on the cumulative value of the color component and the cumulative value of the black after counting by the counting unit.

9. An image forming apparatus comprising:
a determination unit configured to determine whether image data is formed by an image including a predetermined color component; and
a counting unit configured to count up a cumulative value of a rotation number of a photosensitive drum corresponding to the predetermined color component without counting up a cumulative value of a rotation number of a photosensitive drum corresponding to a color component other than the predetermined color component, in a case where the determination unit determines that the image data is formed by an image including the predetermined color component.

10. The image forming apparatus according to claim 9, further comprising a toner remaining amount determination unit configured to determine a toner remaining amount of each color based on the cumulative value of the predetermined color component and the cumulative value of a color component other than the predetermined color component after counting by the counting unit.

11. An image forming method comprising:
determining whether image data is formed by a monochrome image or a color image;
acquiring a rotation number of a photosensitive drum of each color for forming a latent image of the image data, and storing a cumulative value of the acquired rotation number of a photosensitive drum of each color;
correcting a cumulative value corresponding to a color component in the stored cumulative value of each color in a case where it is determined that the image data is formed by a monochrome image; and
determining a toner remaining amount of each color based on the corrected cumulative value of the color component and the stored cumulative value of black.

12. An image forming method comprising:
determining whether image data is formed by an image including a predetermined color component;
acquiring a rotation number of a photosensitive drum of each color for forming a latent image of the image data, and storing a cumulative value of the acquired rotation number of the photosensitive drum of each color;
correcting a cumulative value corresponding to a predetermined color component in the stored cumulative value of each color, in a case where it is determined that the image data is not formed by an image including the predetermined color component; and
determining a toner remaining amount of the predetermined color component based on the corrected cumulative value corresponding to the predetermined color component.

13. An image forming method comprising:
determining whether image data is formed by a monochrome image or a color image; and
counting up a cumulative value of a rotation number of a photosensitive drum corresponding to black without counting up a cumulative value of a rotation number of a photosensitive drum corresponding a color component, in a case where it is determined that the image data is formed by a monochrome image.

14. The image forming method according to claim 13, further comprising determining a toner remaining amount of each color based on the cumulative value of the color component and the cumulative value of the black after the counting.

15. An image forming method comprising:
determining whether image data is formed by an image including a predetermined color component; and
counting up a cumulative value of a rotation number of a photosensitive drum corresponding to the predetermined color component without counting up a cumulative value of a rotation number of a photosensitive drum corresponding a color component other than the predetermined color component, in a case where it is determined that the image data is formed by an image including the predetermined color component.

16. The image forming apparatus according to claim 15, further comprising determining a toner remaining amount of each color based on the cumulative value of the predetermined color component and the cumulative value of a color component other than the predetermined color component after the counting.

17. A computer-readable storage medium storing a program for causing a computer to function as each unit of the image forming apparatus according to claim 1.

18. A computer-readable storage medium storing a program for causing a computer to function as each unit of the image forming apparatus according to claim 4.

19. A computer-readable storage medium storing a program for causing a computer to function as each unit of the image forming apparatus according to claim 7.

20. A computer-readable storage medium storing a program for causing a computer to function as each unit of the image forming apparatus according to claim 9.
